(19) United States
(12) Patent Application Publication
(10) Pub. No.: US 2022/0337760 A1
(43) Pub. Date: Oct. 20, 2022

(54) Drift Glide

(71) Applicant: Sean Devon Brown, Baltimore, MD (US)

(72) Inventor: Sean Devon Brown, Baltimore, MD (US)

(21) Appl. No.: 17/235,160

(22) Filed: Apr. 20, 2021

(51) Int. Cl. H04N 5/262; G11B 27/00

(52) U.S. Cl. CPC H04N 5/262; G11B 27/00

(57) ABSTRACT

Drift Glide is based, created and invented as of style to unite all and every noun(s) ever. To bring all and every noun(s) ever to a simple format and also to expand in a educational, and a creative way. In wholeness, partialness and fullness separates similarities and differences adding of art form of full production of all and every noun(s) ever.

### BACKGROUND

Drift Glide means of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop.

The history started at the beginning of time and of Samuel Hopkins with the very first U.S. patent and utility of Drift Glide of his potash and pearl ash invention's which began the very first utilities and the process structured method of a divided partial full creative art composition production which is part of a Drift Glide. All nouns that were created before and patented after Apr. 10, 1790 is considered of a divided partial full Drift Glide until a divided whole full Drift Glide is produced then new history will start and get added of Drift Glide. Drift Glide represents the past, present and future.

One of the very first motion pictures presented was by the Warner Bros. on Oct. 6, 1927 named “The Jazz Singer” which feature's all six (6) element's (noun(s), sight, movement, sound, source, & effect(s) (fx), all three (3) sub-genre's (vision, sound & technology), all five (5) category's (visual, performance, music, object & media), one (1) of the three (3) types (solid) and one (1) form (one (1) of a divided partial full Drift Glide mainly because of the lack of having the requirement's and guideline's of a divided whole full Drift Glide. “The Jazz Singer” is a specific production in history that had and has the very first capability of becoming of a divided whole full creative art composition production of Drift Glide because of its unique addition of sound of speech (music) but the lack of clause's of the merge and/or blend clips screen style and sound significance of a divided whole full Drift Glide so that puts “The Jazz Singer” in the divided partial full category of a Drift Glide.

### SUMMARY

A Drift Glide is based and comprised upon of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop. The main advantages of a Drift Glide is that it has the capability to keep and continue being created of the universe forever. Also, a huge advantage of a Drift Glide is that a only one (1) style has the capability to express the full meaning plus the existence of life through production as a whole and full from added structure to art in which is called a Drift Glide.

### Drift Glide Description

A Drift Glide consist of a only one (1) main-genre that is divided in which is a whole and partial full creative art composition production. It also consist of six (6) element's, three (3) sub-genre's, five (5) category's, three (3) type's, and five (5) form's.

An example of a divided whole and full Drift Glide is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's, guideline's that are of all six (6) element's (noun(s), sight, movement, sound, source, & effect(s) (fx), all three (3) sub-genre's (vision, sound & technology), all five (5) category's (visual, performance, music, media & object), one (1) and more of the three (3) type's (solid), and one (1) and/or more of the five (5) form's (main-single and/or more, sub-single and/or more, single and/or more, one (1) and/or more, & one (1) and/or more separate) and plus, the specific requirement's and guideline's for the visual category (motion picture) are containing words, merge and/or blend clips screen style at any point and plus, the specific requirement's and guideline's for the performance category (movement) are containing freestyle and/or acting at any point and plus, the specific requirement's and guideline's for the category object (solid, liquid and/or gas) are containing at least one (1) and/or more object(s) and/but a podcast (moving picture & sound) counting as one (1) object and plus, the specific requirement's and guideline's for the music category (sound) are containing two (2) and/or more leads as speech at any point (one and/or more people and/or things) and/or dialogue of two (2) and/or more (people) single lead vocals, but music that is of as a sound of a no gap that is of as a volume level at negative twelve (−12 db) decibels and/or higher constantly throughout an entire one (1) and/or more (form) podcast, and plus also, the specific requirement and guideline for the media category (broadcast) is to contain at least one (1) podcast (moving picture & sound). All and every noun(s) ever is united together of a divided whole full creative art composition production.

An example of a divided partial full Drift Glide is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's, guideline's are of at least five (5) of the six (6) element's (noun(s), sight, movement, source & effect(s) (fx), and one (1) and more of the three (3) sub-genre's (vision), three (3) and more of the five (5) category's (visual, performance & object), and one (1) and more of the three (3) type's (solid), and one (1) and/or more of the five (5) forms (main-single and/or more, sub-single and/or more, single and/or more, one (1) and/or more & one (1) and/or more separate) plus also, the requirement's and guideline's are any lack of clause's of a whole full creative art composition production and is of as a gap of sound and when sound is of as a volume level at negative thirteen (−13 db) decibels higher and/or lower throughout an one (1) and/or more (form) podcast. One, each, some, any, all and/or every noun(s) ever is combined together but all and every noun(s) ever is united together of a divided whole full creative art composition production.

### PHOTOGRAPH(S) DESCRIPTION(S)

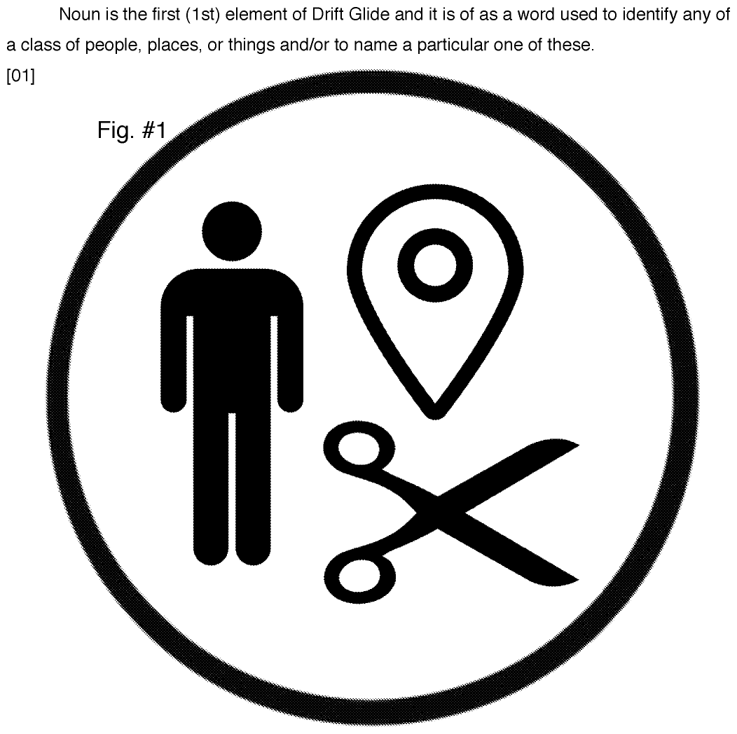

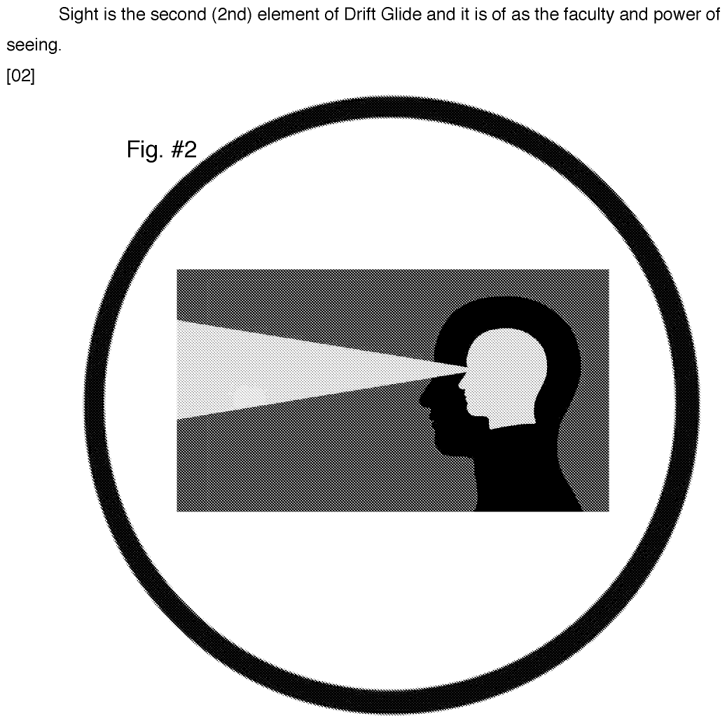

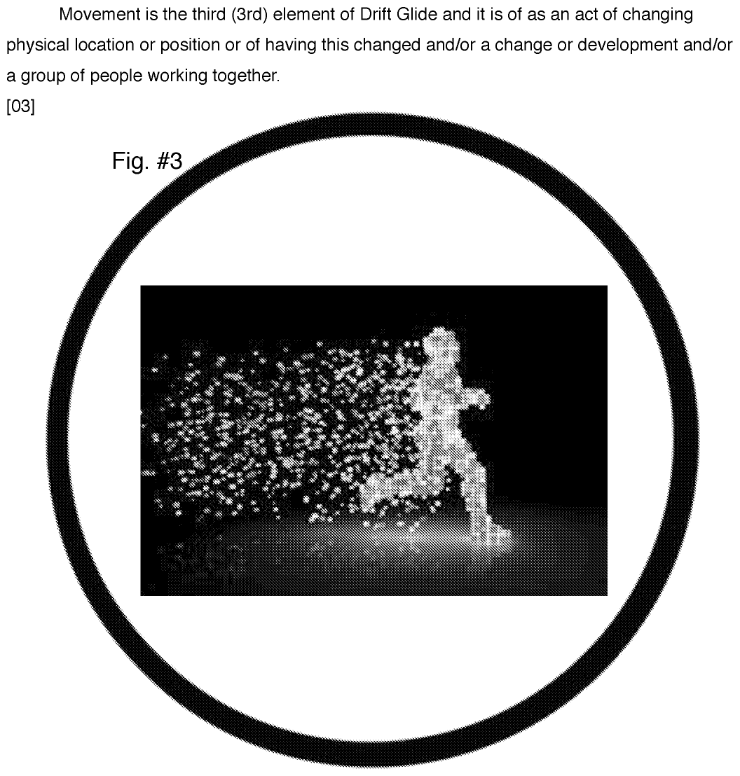

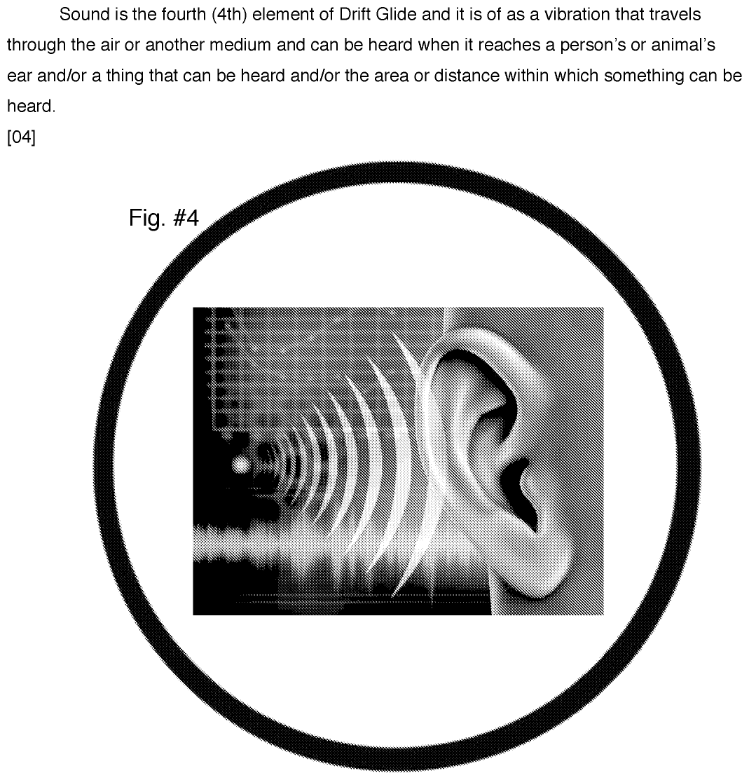

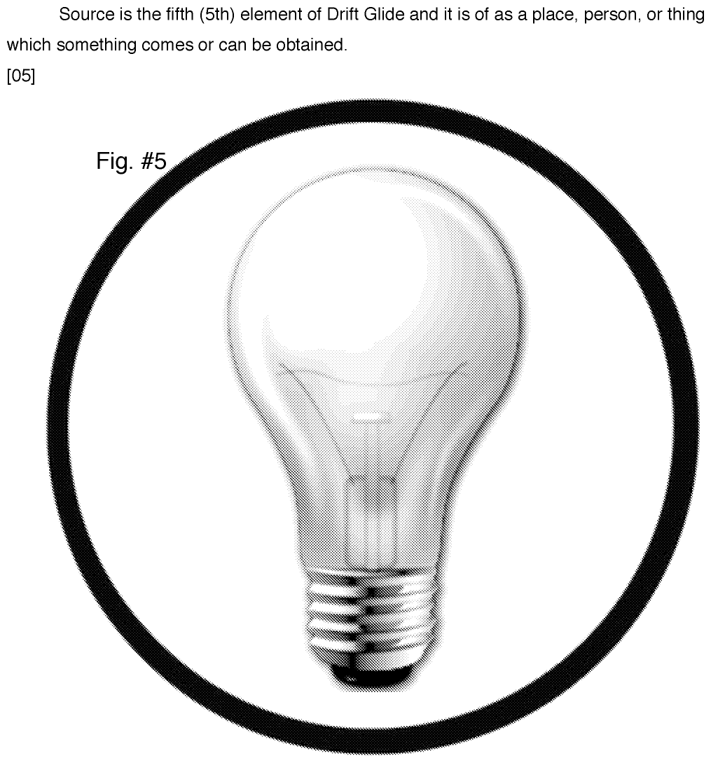

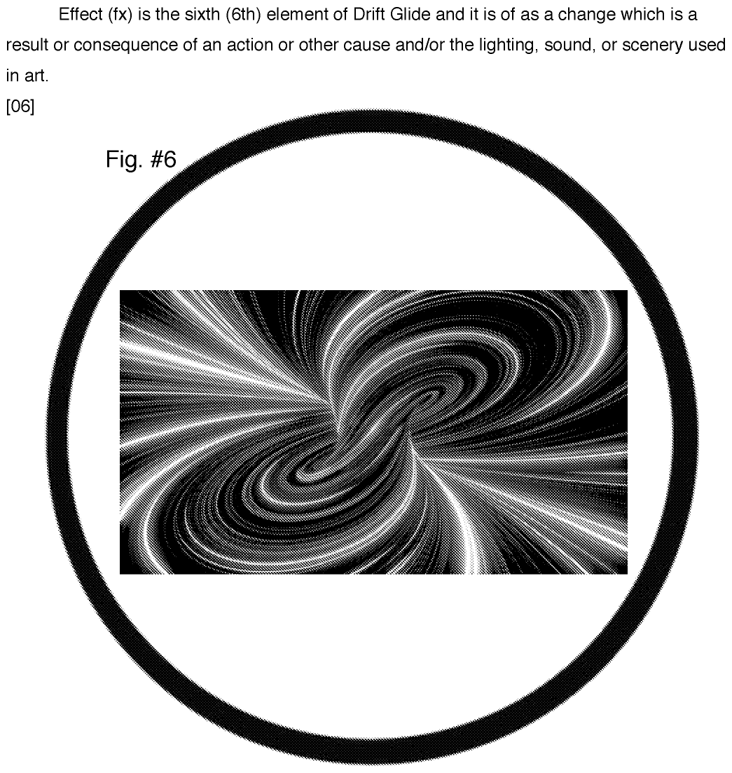

The six (6) element's of a Drift Glide consist's of a noun, sight, movement, sound, source, & effect(s) (fx) that is significant and required of Drift Glide. FIG. 1 “Noun” is the first (1st) element of Drift Glide and it is of as a word used to identify any of a class of people, places, or things and/or to name a particular one of these. FIG. 2 “Sight” is the second (2nd) element of Drift Glide and it is of as the faculty and power of seeing. FIG. 3 “Movement” is the third (3rd) element of Drift Glide and it is of as an act of changing physical location or position or of having this changed and/or a change or development and/or a group of people working together. FIG. 4 “Sound” is the fourth (4th) element of Drift Glide and it is of as a vibration that travels through the air or another medium and can be heard when it reaches a person's or animal's ear and/or a thing that can be heard and/or the area or distance within which something can be heard. FIG. 5 “Source” is the fifth (5th) element of Drift Glide and it is of as a place, person, or thing which something comes or can be obtained. FIG. 6 “Effect” (fx) is the sixth (6th) element of Drift Glide and it is of as a change which is a result or consequence of an action or other cause and/or the lighting, sound, or scenery used in art.

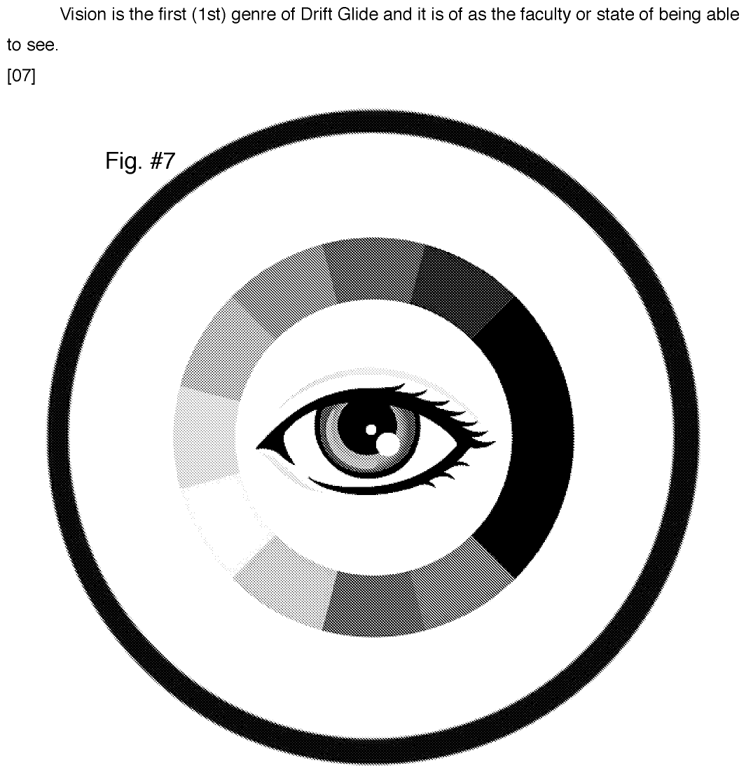

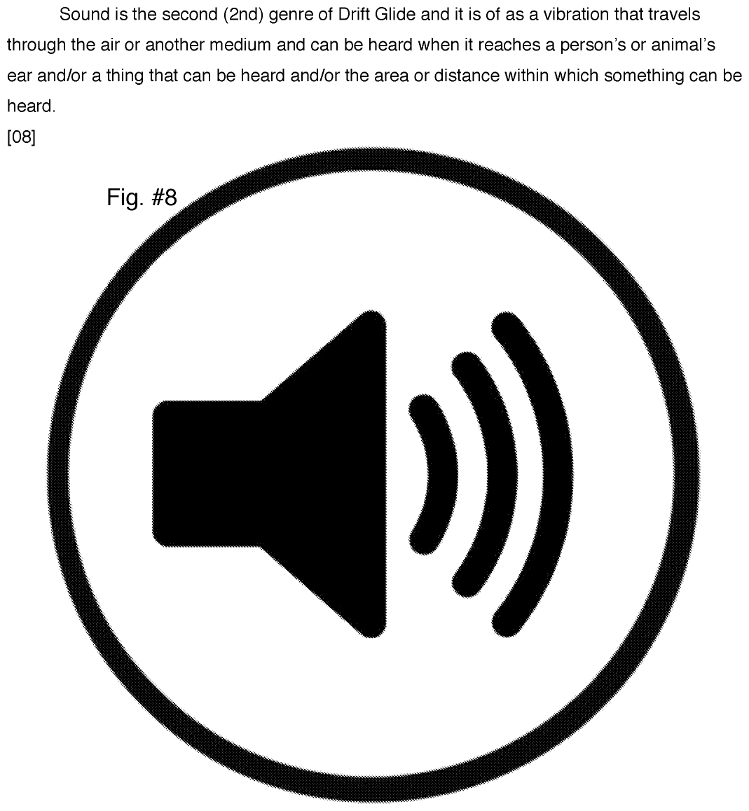

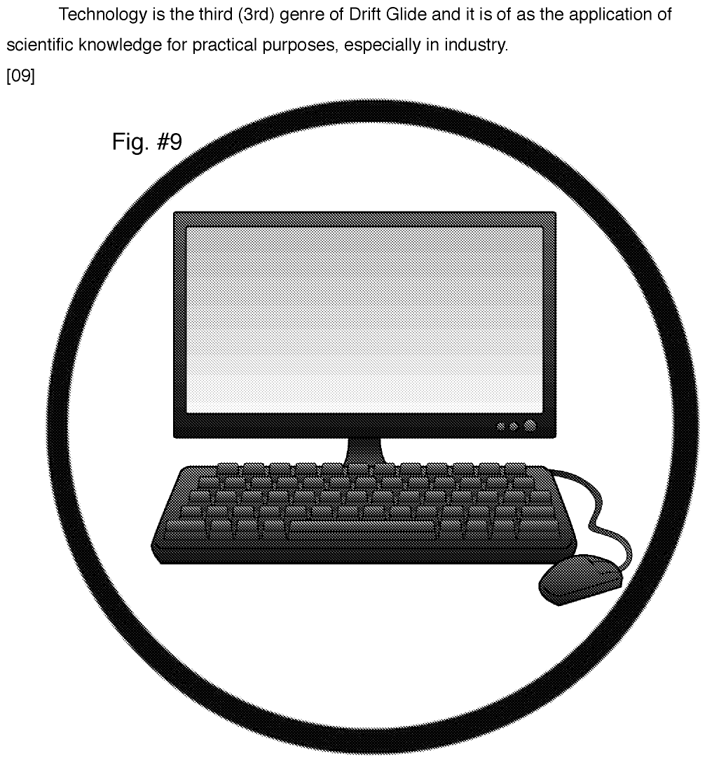

The three (3) sub-genre's of a Drift glide consist's of a vision, sound & technology that is significant and required of Drift Glide. FIG. 7 “Vision” is the first (1st) genre of Drift Glide and it is of as the faculty or state of being able to see. FIG. 8 “Sound” is the second (2nd) genre of Drift Glide and it is of as a vibration that travels through the air or another medium and can be heard when it reaches a person's or animal's ear and/or a thing that can be heard and/or the area or distance within which something can be heard. FIG. 9 “Technology” is the third (3rd) genre of Drift Glide and it is of as the application of scientific knowledge for practical purposes, especially in industry.

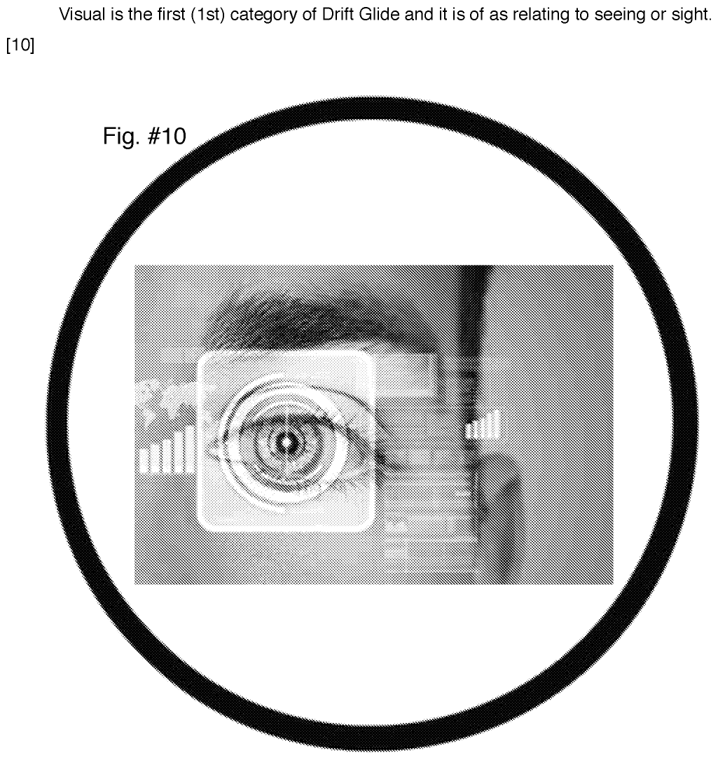

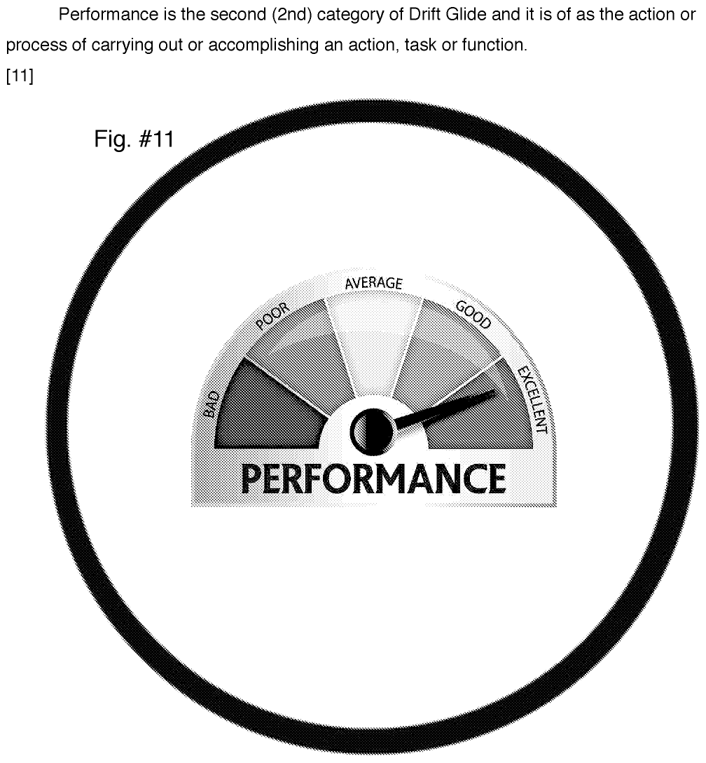

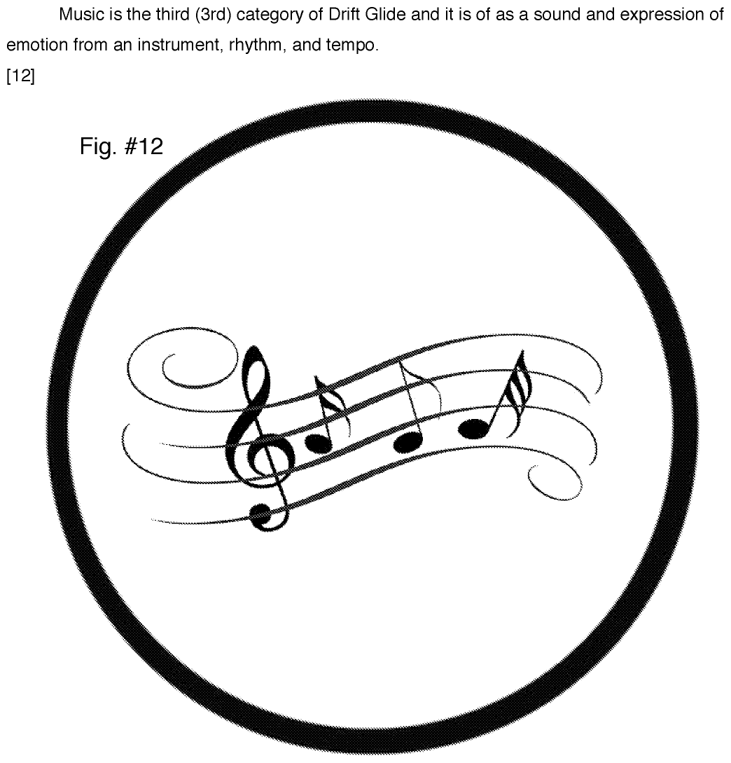

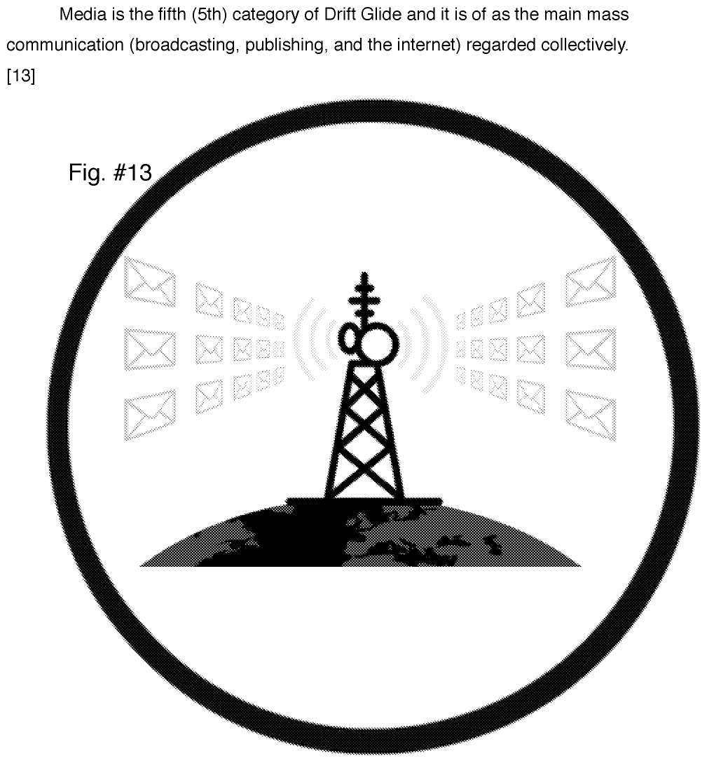

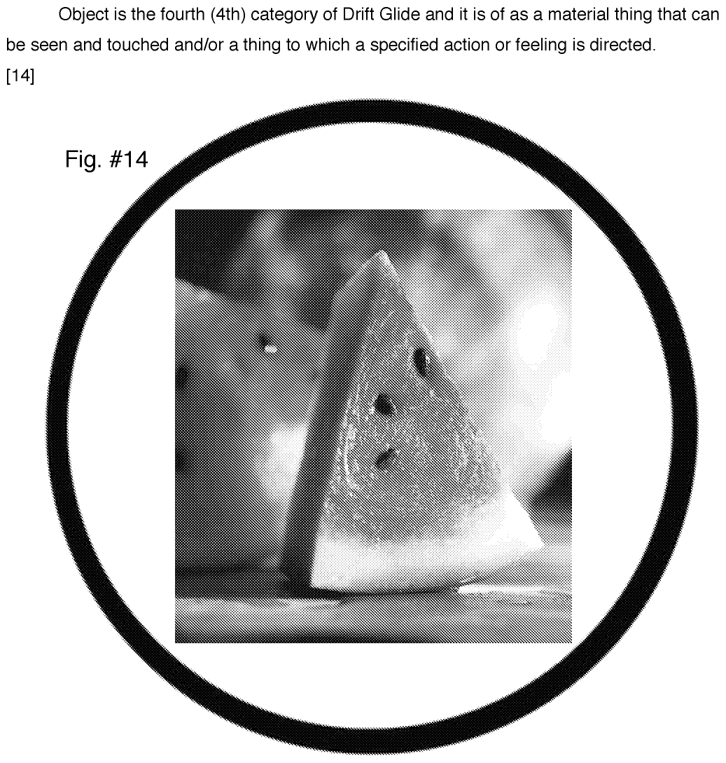

The five (5) category's of a Drift Glide consist's of a visual, performance, music, media & object that is significant and required of Drift Glide. FIG. 10 “Visual” is the first (1st) category of Drift Glide and it is of as relating to seeing or sight. FIG. 11 “Performance” is the second (2nd) category of Drift Glide and it is of as the action or process of carrying out or accomplishing an action, task or function. FIG. 12 “Music” is the third (3rd) category of Drift Glide and it is of as a sound and expression of emotion from an instrument, rhythm, and tempo. FIG. 13 “Media” is the fourth (4th) category of Drift Glide and it is of as the main mass communication (broadcasting, publishing, and the internet) regarded collectively. FIG. 14 “Object” is the fifth (5th) category of Drift Glide and it is of as a material thing that can be seen and touched and/or a thing to which a specified action or feeling is directed.

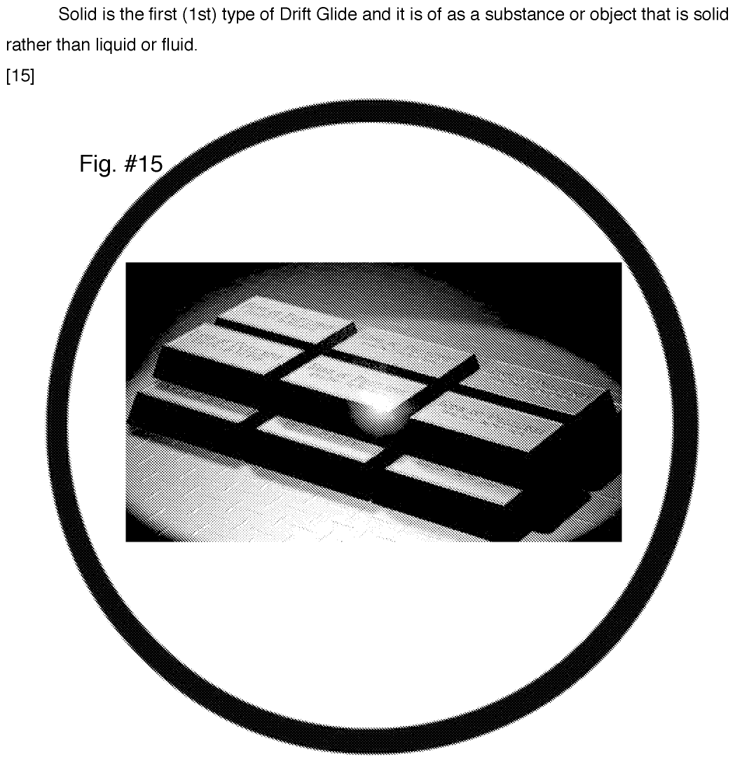

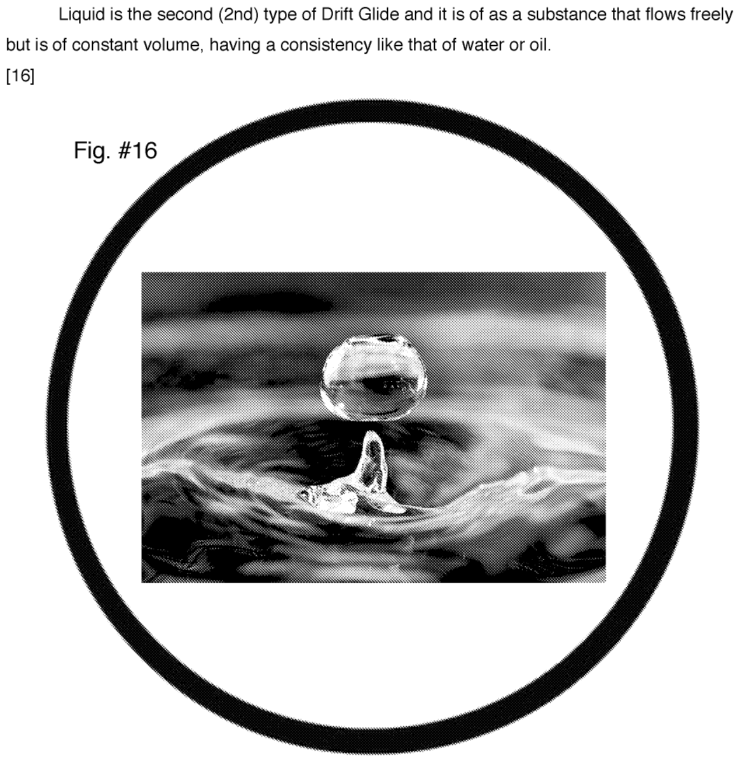

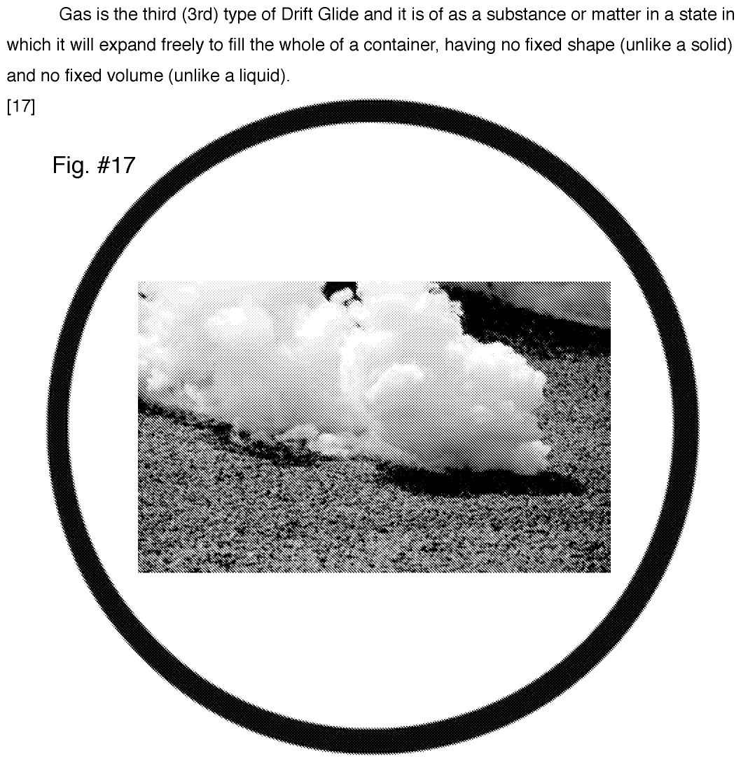

The three (3) type's of a Drift Glide consist's of a solid, liquid and gas that is significant and required of Drift Glide. FIG. 15 “Solid” is the first (1st) type of Drift Glide and it is of as a substance or object that is solid rather than liquid or fluid. FIG. 16 “Liquid” is the second (2nd) type of Drift Glide and it is of as a substance that flows freely but is of constant volume, having a consistency like that of water or oil. FIG. 17 “Gas” is the third (3rd) type of Drift Glide and it is of as a substance or matter in a state in which it will expand freely to fill the whole of a container, having no fixed shape (unlike a solid) and no fixed volume (unlike a liquid).

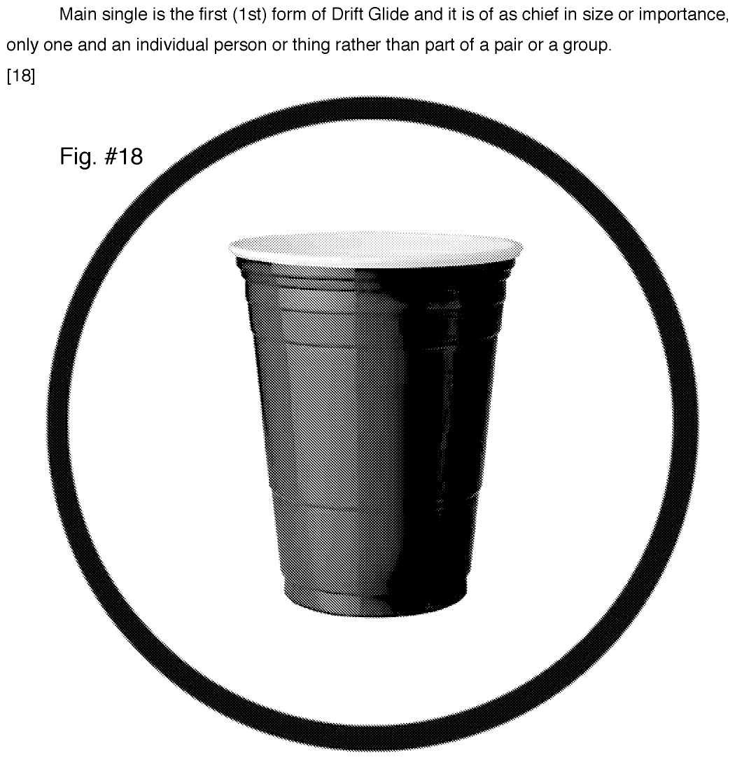

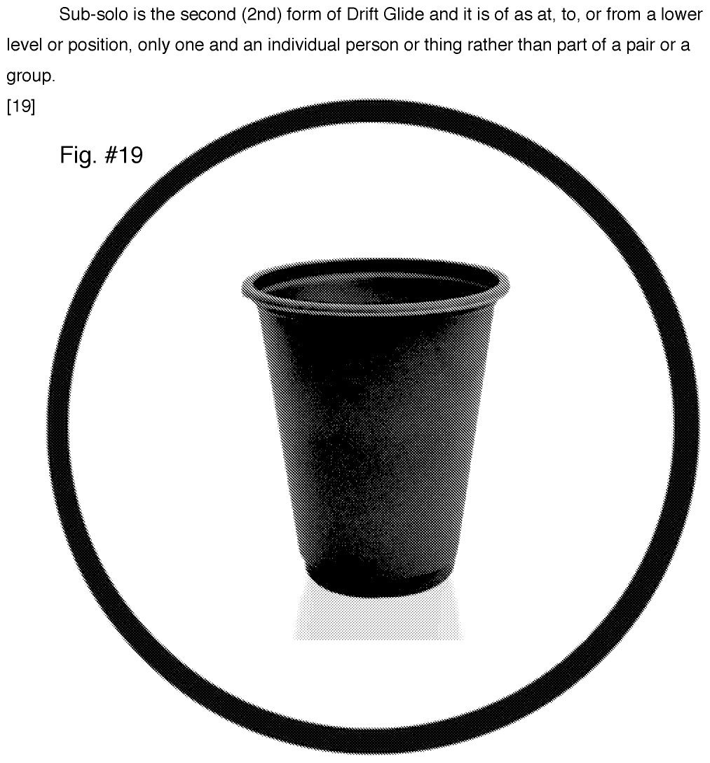

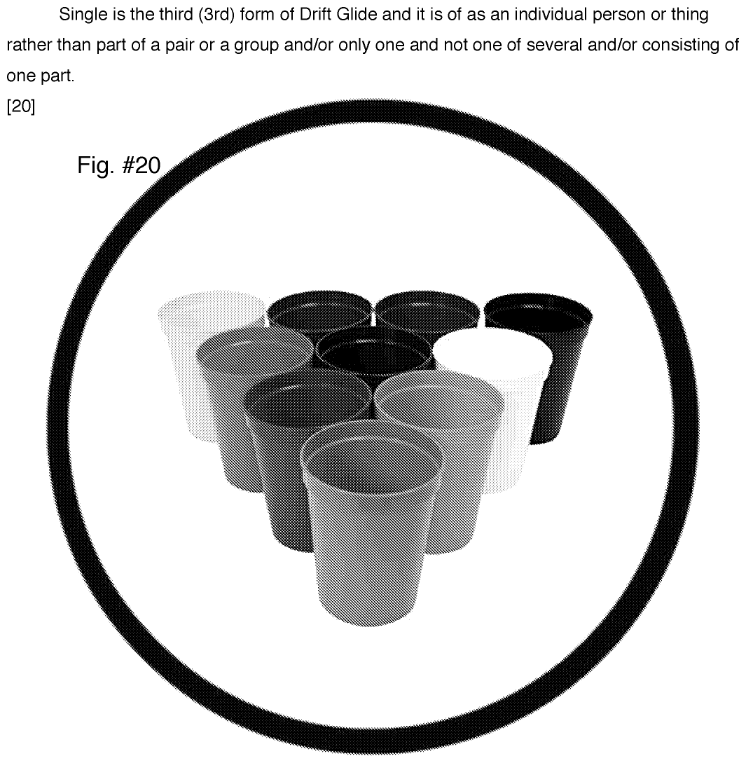

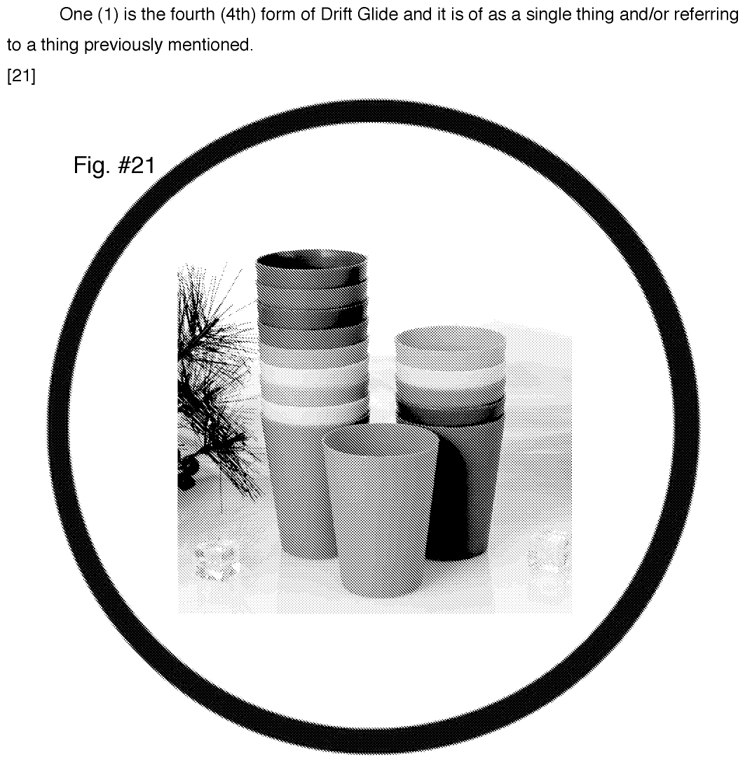

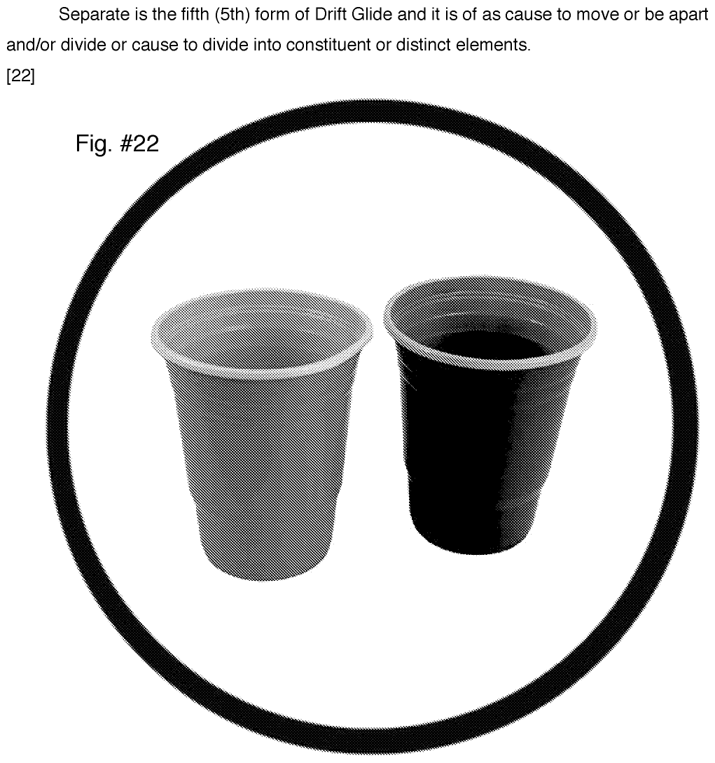

The five (5) form's of a Drift Glide consist's of a main-single and/or more, sub-single and/or more, single and/or more, one and/or more, & one and/or more separate that is significant and required of Drift Glide. FIG. 18 “Main-Single and/or More” is the first (1st) form of Drift Glide and it is of as chief in size or importance, only one and an individual person or thing rather than part of a pair or a group. FIG. 19 “Sub-Single and/or More” is the second (2nd) form of Drift Glide and it is of as at, to, or from a lower level or position, only one and an individual person or thing rather than part of a pair or a group. FIG. 20 “Single and/or More” is the third (3rd) form of Drift Glide and it is of as an individual person or thing rather than part of a pair or a group and/or only one and not one of several and/or consisting of one part. FIG. 21 “One and/or More” (1) is the fourth (4th) form of Drift Glide and it is of as a single thing and/or referring to a thing previously mentioned. FIG. 22 “One and/or More Separate” is the fifth (5th) form of Drift Glide and it is of as cause to move or be apart and/or divide or cause to divide into constituent or distinct elements.

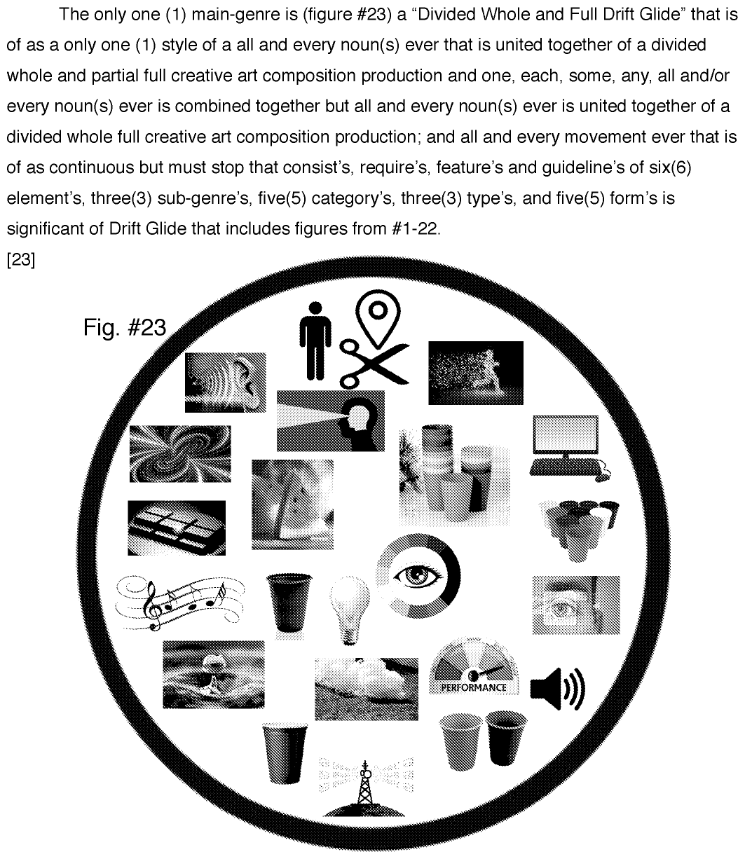

The only one (1) main-genre is (FIG. 23) a “Divided Whole and Full Drift Glide” that is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's and guideline's of six (6) element's, three (3) sub-genre's, five (5) category's, three (3) type's, and five (5) form's is significant of Drift Glide that includes FIGS. 1-22.

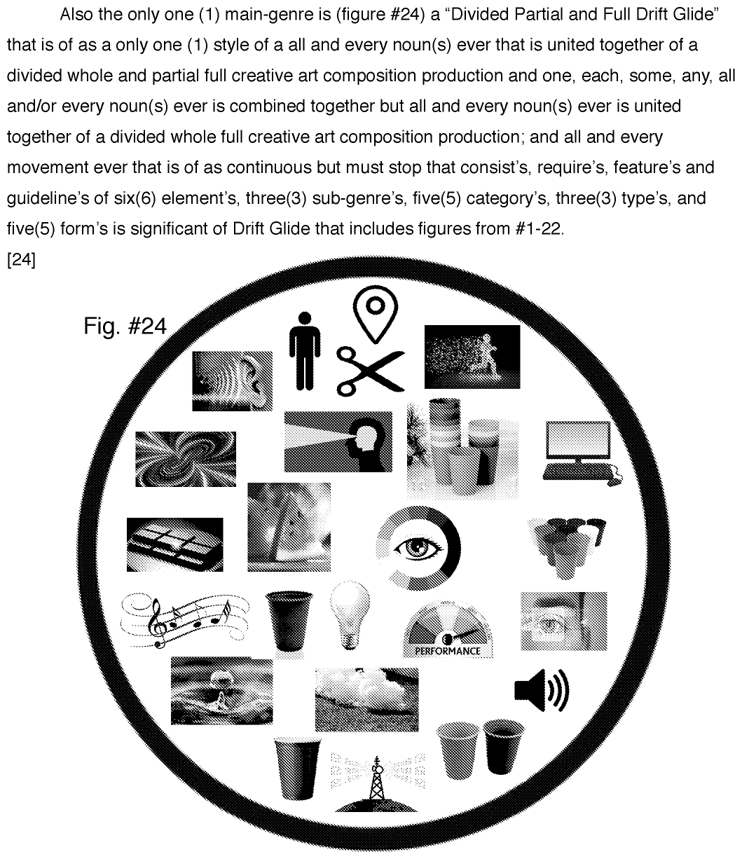

Also the only one (1) main-genre is (FIG. 24) a “Divided Partial and Full Drift Glide” that is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's and guideline's of six (6) element's, three (3) sub-genre's, five (5) category's, three (3) type's, and five (5) form's is significant of Drift Glide that includes FIGS. 1-22.

### REFERENCE

Another substantial utility(s) reference of a Drift Glide is of as all and every noun(s) ever created and made.

### DISCLOSURE

“This invention was made with government support under [the declaration] awarded by [The U.S. Patent and Trademark Office]. The government has certain rights in the invention.”

Everything ever invented, created and made since the beginning of the universe Drift Glide is comprised, structured and based upon all and life to continuously create, produce, record, and promote all and every noun(s) ever in a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that will last forever.

1. A Drift Glide is of as comprising:
of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop.

2. A Drift Glide comprising is of as a apparatus that is of as said in claim one (1) that wherein is of as a only one (1) main-genre that is of as a divided whole and partial full creative art composition production.

3. A Drift Glide comprising is of as a apparatus that is of as said in claim two (2) that wherein is of as a divided whole and partial full creative art composition production that is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's, guideline's that are of all six (6) element's (noun(s), sight, movement, sound, source, & effect(s) (fx), all three (3) sub-genre's vision, sound & technology), all five (5) category's (visual, performance, music, media & object), one (1) and more of the three (3) type's (solid), and one (1) and/or more of the five (5) form's (main-single and/or more, sub-single and/or more, single and/or more, one (1) and/or more, & one (1) and/or more separate) and plus, the specific requirement's and guideline's for the visual category (motion picture) are containing words, merge and/or blend clips screen style at any point and plus, the specific requirement's and guideline's for the performance category (movement) are containing freestyle and/or acting at any point and plus, the specific requirement's and guideline's for the category object (solid, liquid and/or gas) are containing at least one (1) and/or more object(s) and/but a podcast (moving picture & sound) counting as one (1) object and plus, the specific requirement's and guideline's for the music category (sound) are containing two (2) and/or more leads as speech at any point (one and/or more people and/or things) and/or dialogue of two (2) and/or more (people) single lead vocals, but music that is of as a sound of a no gap that is of as a volume level at negative twelve (−12 db) decibels and/or higher constantly throughout an entire one (1) and/or more (form) podcast, and plus also, the specific requirement and guideline for the media category (broadcast) is to contain at least one (1) podcast (moving picture & sound) and all and every noun(s) ever is united together.

4. A Drift Glide comprising is of as a apparatus that is of as said in claim two (2) that wherein is of as a divided partial full creative art composition production that is of as a only one (1) style of a all and every noun(s) ever that is united together of a divided whole and partial full creative art composition production and one, each, some, any, all and/or every noun(s) ever is combined together but all and every noun(s) ever is united together of a divided whole full creative art composition production; and all and every movement ever that is of as continuous but must stop that consist's, require's, feature's, guideline's are of at least five (5) of the six (6) element's (noun(s), sight, movement, source & effect(s) (fx), and one (1) and more of the three (3) sub-genre's (vision), three (3) and more of the five (5) category's (visual, performance & object), and one (1) and more of the three (3) type's (solid), and one (1) and/or more of the five (5) forms (main-single and/or more, sub-single and/or more, single and/or more, one (1) and/or more & one (1) and/or more separate) plus also, the requirement's and guideline's are any lack of clause's of a whole full creative art composition production and is of as a gap of sound and when sound is of as a volume level at negative thirteen (−13 db) decibels higher and/or lower throughout an one (1) and/or more (form) podcast and one, each, some, any, all and/or every noun(s) ever is combined together but all and every noun(s) ever is united together.

5. A Drift Glide comprising is of as a apparatus that is of as said in claim two (2) that wherein is of as six (6) elements that is of as a noun, sight, movement, sound, source, and effect (fx);
is of as a noun that is of as a word used to identify any of a class of people, places, or things and/or to name a particular one of these;
is of as a sight that is of as the faculty and power of seeing;
is of as a movement that is of as an act of changing physical location or position or of having this changed and/or a change or development and/or a group of people working together;
is of as a sound that is of as a vibration that travels through the air or another medium and can be heard when it reaches a person's or animal's ear and/or a thing that can be heard and/or the area or distance within which something can be heard;
is of as a source that is of as a place, person, or thing which something comes or can be obtained;
is of as a effect (fx) that is of as a change which is a result or consequence of an action or other cause and/or the lighting, sound, or scenery used in a art;
is of as three (3) sub-genres that is of as a vision, sound, and technology;
is of as a vision that is of as the faculty or state of being able to see;
is of as a sound that is of as a vibration that travels through the air or another medium and can be heard when it reaches a person's or animal's ear and/or a thing that can be heard and/or the area or distance within which something can be heard;
is of as a technology that is of as the application of scientific knowledge for practical purposes, especially in industry;
is of as five (5) categories that is of as a visual, performance, music, media and object;
is of as a visual that is of as relating to seeing or sight;
is of as a performance that is of as the action or process of carrying out or accomplishing an action, task or function;
is of as a music that is of as a sound and expression of emotion from an instrument, rhythm, and tempo;
is of as a media that is of as the main mass communication (broadcasting, publishing, and the internet) regarded collectively;
is of as a object that is of as a material thing that can be seen and touched and/or a thing to which a specified action or feeling is directed;
is of as three (3) types that is of as a solid, liquid, and gas;
is of as a solid that is of as a substance or object that is solid rather than liquid or fluid;
is of as a liquid that is of as a substance that flows freely but is of constant volume, having a consistency like that of water or oil;
is of as a gas that is of as a substance or matter in a state in which it will expand freely to fill the whole of a container, having no fixed shape (unlike a solid) and no fixed volume (unlike a liquid);
is of as five (5) forms that is of as a main-single and/or more, sub-single and/or more, single and/or more, one (1) and/or more, and a one (1) and/or more separate;
is of as a main-single that is of as a chief in size or importance, only one and an individual person or thing rather than part of a pair or a group;
is of as a sub-single that is of as at, to, or from a lower level or position, only one and an individual person or thing rather than part of a pair or a group;
is of as a single that is of as an individual thing rather than part of a pair or a group and/or only one and not one of several and/or consisting of one part;
is of as a one (1) that is of as a single thing and/or referring to a thing previously mentioned;
is of as a separate that is of as a cause to move or be apart and/or divide or cause to divide into constituent or distinct elements of;
is of as a more that is of as a greater or additional amount or degree of.
